(19) United States
(12) Patent Application Publication
(10) Pub. No.: US 2015/0075828 A1
(43) Pub. Date: Mar. 19, 2015

(54) HANDHELD TOOL DEVICE

(71) Applicant: Tobias Herr, Stuttgart (DE)

(72) Inventor: Tobias Herr, Stuttgart (DE)

(21) Appl. No.: 14/368,469

(22) PCT Filed: Dec. 19, 2012
(86) PCT No.: PCT/EP2012/076201

§ 371 Date: Jun. 24, 2014

(30) Foreign Application Priority Data
Dec. 27, 2011 (DE) 10 2011 089 910.3

(51) Int. Cl. B25D 17/06; B25D 16/00

(52) U.S. Cl. CPC B25D 17/06; B25D 16/00
USPC 173/48

(57) ABSTRACT

A handheld tool device includes a hammer mechanism that has at least a striker and a cam guide that drives the striker at least in a hammer-drilling mode. The striker has at least a portion of the cam guide.

### BACKGROUND OF THE INVENTION

1. Field of the Invention

The present invention relates to a handheld tool device with a hammer mechanism.

2. Description of the Related Art

Published European Patent Application document EP 1 690 642 A1 has already described a handheld tool device with a hammer mechanism that has at least a striker and a cam guide that drives the striker at least in a hammer-drilling mode.

### BRIEF SUMMARY OF THE INVENTION

The present invention proceeds from a handheld tool device with a hammer mechanism that has at least a striker and a cam guide that drives the striker at least in a hammer-drilling mode.

It is provided that the striker has at least a portion of the cam guide. The term “hammer mechanism” is to be understood as meaning especially a device that is intended to produce an impact pulse and to deliver it especially in the direction of an application tool. Preferably, the hammer mechanism transmits the impact pulse to the application tool, at least in a hammer-drilling mode, advantageously via a tool spindle and/or especially via a tool chuck of the handheld tool device. Preferably, the hammer mechanism is intended for translating a rotational motion into a, in particular, translational hammer motion. The term “intended” is to be understood as meaning especially being specifically designed and/or equipped. In particular, the term “striker” is to be understood as meaning an element that, at least in a hammer-drilling mode, is accelerated, in particular translationally and that delivers a pulse received during the acceleration as an impact pulse in the direction of the application tool. Preferably, the striker is constructed in one piece. Alternatively, the striker could be of a multi-part configuration. In particular, a “cam guide” is to be understood as being a device that translates rotational energy into linear motion energy of the striker to produce an impact at least with the aid of a specially shaped guide surface along which a connecting element runs at least in a hammer-drilling mode. Preferably, the hammer mechanism has a hammer mechanism spring which stores the linear motion energy of the striker to produce an impact. Preferably, the specially shaped surface is a surface that delimits a guide cam of the cam guide.

A “connecting element” is to be understood especially as being an element that produces a mechanical coupling between at least one part of the hammer mechanism, which part is moved in rotation in a hammer-drilling mode, especially a hammer mechanism spindle, and the striker which is moved, in particular, linearly. In particular, a “guide cam” is to understood as being a region that is delimited by the guide surface and in which the connecting element runs in at least one operating state. A “hammer mechanism spring” is to be understood especially as being a spring that stores at least some of an impact energy in at least one operating state. In particular, the term “support” is to be understood as meaning that a portion of the hammer mechanism spring is disposed so as to be immobile relative to the striker, or a portion of the hammer mechanism spring is disposed so as to be immobile relative to a handheld tool housing. The hammer mechanism spring is configured as a spring considered suitable by one skilled in the art, but preferably is configured as a helical spring. The term “drive” is to be understood in this context as meaning especially that the cam guide transmits to the striker an energy for producing an impact.

The expression “the striker has at least a portion of the cam guide” is to be understood especially as meaning that the striker has a surface to which the connecting element directly transmits the energy for producing the impact motion. Preferably, the portion of the cam guide belonging to the striker is configured as a surface that fastens the connecting element in a fixed position relative to the striker. Advantageously, the portion of the cam guide belonging to the striker includes a fastening recess which is delimited by the surface and which fastens the connecting element in a fixed position relative to the striker. Advantageously, the striker is intended to fasten a connecting element that in an operation connects the portion of the cam guide and a further portion of the cam guide, especially the guide cam.

Preferably, the connecting element and the striker are connected in an unsprung manner. That means, in particular, that no spring is operatively disposed between the connecting element and the striker. Alternatively, the connecting element could be constructed at least partially in one piece with the striker. Furthermore, as an alternative, the portion of the cam guide belonging to the striker could be configured as a guide cam. The expression “in a fixed position” is to be understood especially as meaning that an axis of symmetry and/or a center point of the connecting means is at least substantially motionless relative to the striker in a hammer mode. The configuration according to the invention of the handheld tool device is able to provide an especially small, light-weight and nevertheless effective hammer mechanism. In particular, it is advantageously possible to dispense with a wobble bearing or a rocker lever.

In a further embodiment, it is provided that the cam guide has an impact free-running region, whereby, with a short overall length, a high impact energy and an advantageously low degree of wear may be achieved. An “impact free-running region” is to be understood especially as being a region of the guide cam of the cam guide, in which region the connecting element is disposed when the hammer mechanism spring accelerates the striker in the impact direction. Preferably, the impact free-running region is constructed to be so wide that the connecting element is able to run through the impact free-running region on different paths. Preferably, the impact free-running region does not cause any force on the striker, at least in the hammer-drilling mode.

Furthermore, it is provided that the cam guide has an impact pull-up region, whereby advantageous operation, especially with little vibration, may be achieved. In particular, an “impact pull-up region” is to be understood as being a region of the guide cam of the cam guide, which region moves the striker, at least in a hammer-drilling mode, especially relative to the handheld tool housing counter to the impact direction. Preferably, the movement of the striker counter to the impact direction, which is caused by the impact pull-up region, compresses the hammer mechanism spring. Preferably, the guide surface of the impact pull-up region has an inclination relative to the impact direction of from 5 degrees to 35 degrees, preferably from 10 degrees to 25 degrees.

It is further provided that the cam guide has a mounting aperture, whereby advantageous mounting and an especially small construction are possible. A “mounting aperture” is to be understood especially as being a region delimited by the hammer mechanism spindle and/or the striker, through which the connecting element is introduced into the guide cam during mounting.

In addition, it is provided that the hammer mechanism includes a hammer mechanism spindle which has at least a portion of the cam guide, whereby a compact configuration may be achieved. A “hammer mechanism spindle” is to be understood especially as being a shaft that transmits rotational motion from a planetary gear of the handheld tool device to the cam guide. Preferably, the hammer mechanism spindle is in the form of a hollow shaft.

It is furthermore provided that the hammer mechanism spindle has a guide cam of the cam guide, whereby simple manufacture is possible. Alternatively or in addition, the hammer mechanism spindle could have a fastening recess for fastening of the connecting element in a fixed position relative to the hammer mechanism spindle and/or could be constructed at least partially in one piece with the connecting element.

In one advantageous embodiment of the present invention, it is provided that the striker at least substantially surrounds the hammer mechanism spindle on at least one plane, whereby a configuration of low volume and weight is possible. In particular, the expression “at least substantially surround on at least one plane” is to be understood as meaning that radial lines emanating from an axis of the hammer mechanism spindle and disposed on the plane will intersect the striker over an angle range of at least 180 degrees, advantageously at least 270 degrees. Especially advantageously, the striker surrounds the hammer mechanism spindle by 360 degrees.

In a further embodiment, it is provided that the hammer mechanism has a connecting element which in at least one operating state transmits a motion especially from the hammer mechanism spindle to the striker, whereby a low degree of wear, efficient production and simple mounting may be achieved.

Furthermore, it is provided that the handheld tool device has a tool spindle which the striker at least substantially surrounds on at least one plane. A “tool spindle” is to be understood as being especially a shaft that transmits rotational motion from the planetary gear to the tool chuck. Preferably, the tool spindle is in the form of a solid shaft. Alternatively, the tool spindle could be in the form of a hollow shaft.

It is further provided that the tool spindle is disposed at least substantially coaxially with the hammer mechanism spindle, whereby an especially compact configuration is possible. In particular, the expression “disposed at least substantially coaxially” is to be understood as meaning that, at at least one point, a rotation axis of the tool spindle and a rotation axis of the hammer mechanism spindle are spaced from each other by less than 20 mm, advantageously less than 10 mm, and have an orientation difference of less than 15 degrees, advantageously less than 5 degrees, from each other. Especially preferably, the rotation axis of the tool spindle and the rotation axis of the hammer mechanism spindle are disposed on an identical straight line and have an identical orientation.

In addition, it is provided that the hammer mechanism has a striker guide which supports the striker in a rotationally rigid manner, whereby a constructionally simple cam guide is possible. A “striker guide” is to be understood especially as being a device that supports the striker to be movable parallel to the impact direction. In particular, the expression “support in a rotationally rigid manner” is to be understood as meaning that the striker guide opposes in particular any rotational movement of the striker relative to a handheld tool housing.

It is further provided that the handheld tool device includes a handheld tool housing, the hammer mechanism having a hammer mechanism spring which is supported on the striker and on the handheld tool housing, whereby an especially small overall axial length may be achieved. In particular, a “handheld tool housing” is to be understood as being a housing having an interior space in which at least the hammer mechanism, the planetary gear, and a drive unit of the handheld tool housing are disposed.

Preferably, the handheld tool housing connects at least the hammer mechanism, the planetary gear, and a drive unit of the handheld tool housing at least partially to one another.

In one advantageous embodiment of the present invention, it is provided that the hammer mechanism has the first cam guide and a second cam guide, whereby a low degree of wear and a high smoothness of running are possible.

In addition, the present invention proceeds from a handheld tool having a handheld tool device according to the invention. Preferably, the handheld tool is intended to drive the application tool in a screwing mode, in a drilling mode, in a screwing/drilling mode and especially in a chisel mode.

### BRIEF DESCRIPTION OF THE DRAWINGS

FIG. 1 shows a section of a handheld tool with a handheld tool device according to the invention.

FIG. 2 shows a partially isolated section through a hammer mechanism and a planetary gear of the handheld tool device of FIG. 1.

FIG. 3 shows a first plane of section A of the hammer mechanism of the handheld tool device of FIG. 1.

FIG. 4 shows a second plane of section B of the hammer mechanism of the handheld tool device of FIG. 1.

FIG. 5 shows a perspective view of a hammer mechanism spindle of the hammer mechanism of the handheld tool device of FIG. 1.

FIG. 6 shows a perspective view of a striker of the hammer mechanism of the handheld tool device of FIG. 1.

FIG. 7 shows a plane of section C of a first planetary gear stage and a first impact deactivation device of the handheld tool device of FIG. 1.

FIG. 8 shows a plane of section D of a control element and a second impact deactivation device of the handheld tool device of FIG. 1.

FIG. 9 shows a perspective view in section of a portion of the handheld tool device of FIG. 1.

FIG. 10 shows a plane of section E of a spindle locking device of the handheld tool device of FIG. 1.

FIG. 11 shows a plane of section F through blocking elements of the spindle locking device of the handheld tool device of FIG. 1.

FIG. 12 shows a plane of section G of a second planetary gear stage of the handheld tool device of FIG. 1.

FIG. 13 shows a plane of section H of a third planetary gear stage of the handheld tool device of FIG. 1.

FIG. 14 shows a plane of section I of a fourth planetary gear stage of the handheld tool device of FIG. 1.

FIG. 15 shows a schematic representation of an operating device and a safety device of the handheld tool device of FIG. 1.

FIG. 16 shows an alternative exemplary embodiment of a first impact deactivation device of a handheld tool device according to the invention.

FIG. 17 shows a further exemplary embodiment of a first impact deactivation device of a handheld tool device according to the invention.

FIG. 18 shows an alternative exemplary embodiment of an impact switch spring of a handheld tool device according to the invention.

FIG. 19 shows an alternative exemplary embodiment of an operating device and a safety device of a handheld tool device according to the invention.

### DETAILED DESCRIPTION OF THE INVENTION

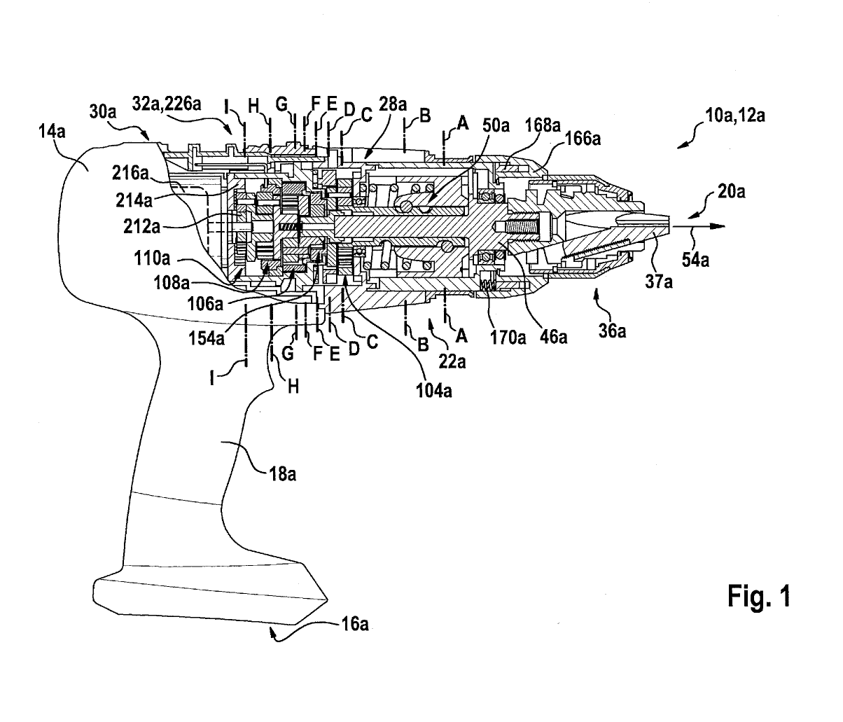

FIG. 1 shows a handheld tool 10a. Handheld tool 10a is in the form of a hammer drill driver. Handheld tool 10a has a handheld tool device 12a according to the invention, a handheld tool housing 14a and a battery interface 16a. Battery interface 16a is intended to supply handheld tool device 12a with electrical energy from a handheld tool battery, not shown. Handheld tool housing 14a is of a pistol-shaped configuration. Handheld tool housing 14a is of a multi-part configuration. It includes a hand grip 18a with which an operator holds the handheld tool 10a during a work operation. Handheld tool device 12a includes a tool guiding unit 20a, a hammer mechanism 22a, a first impact deactivation device 24a, a second impact deactivation device 26a, a planetary gear 28a, a drive unit 30a, an operating device 32a, and a torque limiting unit 34a.

Tool guiding unit 20a includes a tool chuck 36a and a tool spindle 38a. During a work operation, tool chuck 36a fastens an application tool, not shown here, for example a drill bit or a driver bit. Tool chuck 36a fastens the application tool non-positively. Tool chuck 36a has three clamping jaws which are movably fastened by an operator and which fasten the application tool in a work operation. In addition, tool chuck 36a fastens the application tool in such a way that it is axially immobile relative to tool chuck 36a and especially tool spindle 38a in a work operation. A portion of tool chuck 36a and tool spindle 38a are connected to each other in such a way as to be immobile relative to each other. In this case, tool chuck 36a and tool spindle 38a are screwed to each other. Handheld tool device 12a has a bearing element 40a which supports tool spindle 38a on a side toward tool chuck 36a. Bearing element 40a supports tool spindle 38a in an axially displaceable manner. Bearing element 40a is connected to tool spindle 38a in an axially fixed manner. Bearing element 40a is supported to be axially movable in handheld tool housing 14a. Handheld tool device 12a has a further bearing element 41a which supports tool spindle 38a on a side toward planetary gear 28a. Bearing element 41a is in the form of a rolling bearing, in this case a needle bearing, whereby low-backlash support is possible. Bearing element 41a supports tool spindle 38a in an axially displaceable manner. A hammer mechanism spindle 46a surrounds bearing element 41a. Bearing element 41a is operatively disposed between tool spindle 38a and hammer mechanism spindle 46a.

Tool spindle 38a includes an impact face 42a on which a striker 44a of hammer mechanism 22a strikes in a hammer-drilling mode. Striker 44a has a mass that is at most two thirds as great as a mass of tool guiding unit 20a. In this case, the mass of striker 44a is less than half as great as the mass of tool guiding unit 20a. The mass of striker 44a is approximately 45% of the mass of tool guiding unit 20a.

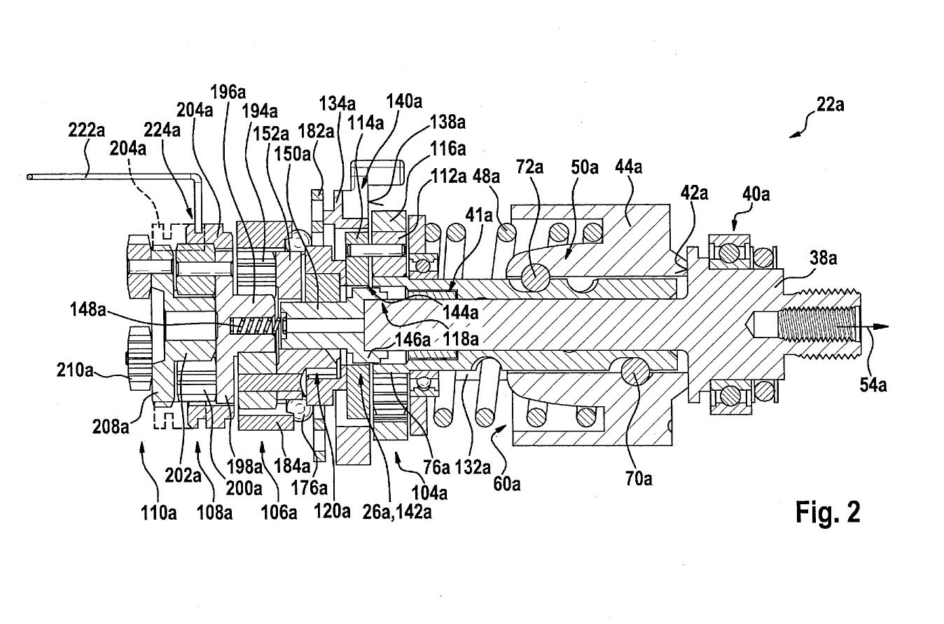

In FIG. 2, hammer mechanism 22a and planetary gear 28a are illustrated in greater detail. Hammer mechanism 22a has striker 44a, hammer mechanism spindle 46a, a hammer mechanism spring 48a, a striker driving device 50a, and a striker guide 52a. Striker 44a is supported to be movable translationally in impact direction 54a. Impact direction 54a is oriented parallel to an axial direction of hammer mechanism spindle 46a.

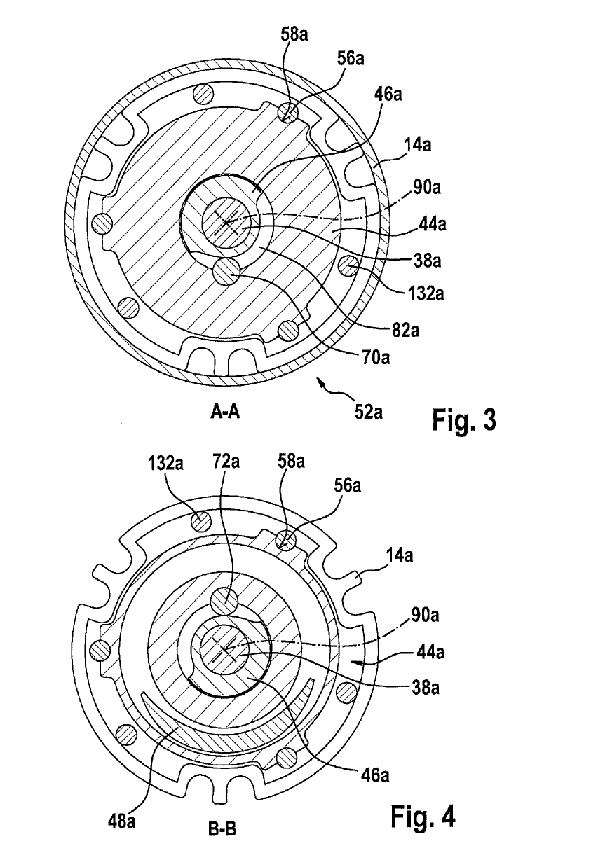

FIGS. 3 and 4 show a plane of section A and a plane of section B of hammer mechanism 22a. Striker guide 52a supports striker 44a in a rotationally rigid manner relative to handheld tool housing 14a. Striker guide 52a has three guide rods 56a on which striker 44a slides. Guide rods 56a are disposed at uniform intervals about striker 44a. Striker 44a has slide surfaces 58a which surround guide rods 56a by 180 degrees on a plane perpendicular to impact direction 54a. Striker 44a surrounds hammer mechanism spindle 46a by 360 degrees on a plane oriented perpendicularly to impact direction 54a. In addition, striker 44a surrounds tool spindle 38a on the plane by 360 degrees. Furthermore, hammer mechanism spindle 46a surrounds tool spindle 38a on the plane by 360 degrees. Hammer mechanism spindle 46a is disposed coaxially with tool spindle 38a.

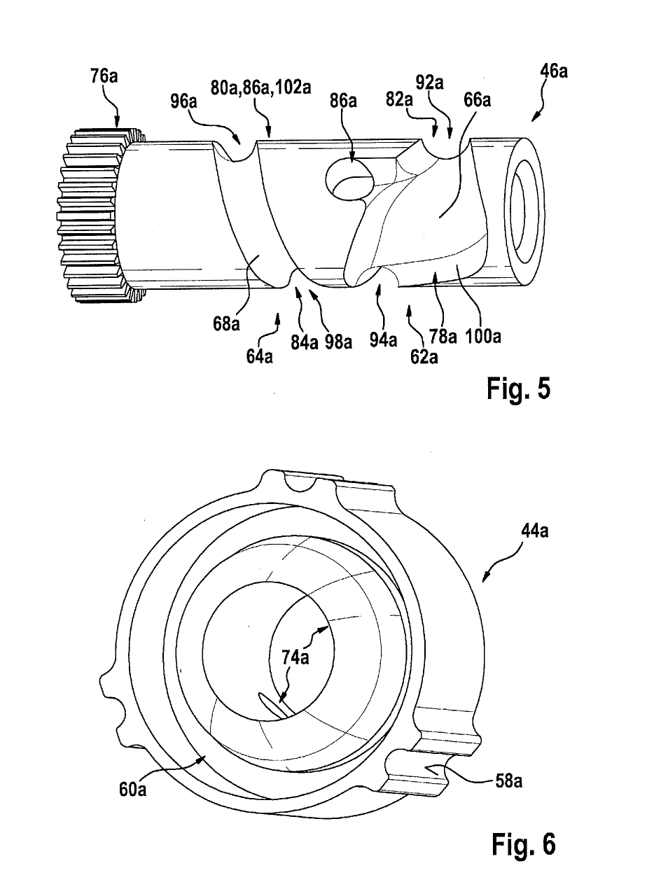

Hammer mechanism spring 48a accelerates striker 44a in impact direction 54a prior to an impact. For that purpose, handheld tool housing 14a supports hammer mechanism spring 48a on a side remote from striker 44a. Hammer mechanism spring 48a presses directly against striker 44a. Striker 44a has a spring fastening 60a. Spring fastening 60a is in the form of an annular depression. FIG. 5 shows hammer mechanism spindle 46a in perspective. FIG. 6 shows striker 44a in perspective. Striker driving device 50a has a first cam guide 62a and a second first cam guide 64a. Cam guides 62a, 64a each include a respective guide cam 66a, 68a and a respective connecting element 70a, 72a. Connecting elements 70a, 72a are of a spherical configuration. Striker 44a supports connecting elements 70a, 72a in a fixed position relative to striker 44a. Striker 44a has hemispherical fastening recesses 74a. Connecting elements 70a, 72a slide in guide cam 66a, 68a in a hammer-drilling mode. Hammer mechanism spindle 46a has a portion of cam guides 62a, 64a, namely guide cam 66a, 68a. Hammer mechanism spindle 46a delimits a space in which connecting elements 70a, 72a move in a hammer-drilling mode.

Hammer mechanism spindle 46a is in the form of a hollow shaft. Planetary gear 28a drives hammer mechanism spindle 46a. For that purpose, hammer mechanism spindle 46a has toothing 76a on a side remote from tool chuck 36a. Guide cams 66a, 68a each have an impact free-running region 78a, 80a, an impact pull-up region 82a, 84a and a mounting aperture 86a, 88a. In a mounting operation, connecting elements 70a, 72a are introduced into fastening recesses 74a of striker 44a through mounting apertures 86a, 88a. Hammer mechanism spindle 46a rotates in the hammer-drilling mode in the clockwise direction as viewed in impact direction 54a. Impact pull-up regions 82a, 84a are of a helical configuration. They extend through 180 degrees about a rotation axis 90a of hammer mechanism spindle 46a. Impact pull-up regions 82a, 84a move connecting elements 70a, 72a and hence striker 44a counter to impact direction 54a in the hammer-drilling mode. Accordingly, hammer mechanism 22a includes connecting elements 70a, 72a which, in at least one operating state, transmit a motion from hammer mechanism spindle 46a to striker 44a.

Impact free-running regions 78a, 80a each connect two ends 92a, 94a, 96a, 98a of impact pull-up regions 82a, 84a. Impact free-running regions 78a, 80a extend through 180 degrees about a rotation axis 90a of hammer mechanism spindle 46a. Impact free-running regions 78a, 80a each have an impact flank 100a, 102a which, starting from an end 94a, 96a of impact pull-up region 82a toward planetary gear 28a, runs approximately parallel to impact direction 54a. Once connecting elements 70a, 72a penetrate into impact free-running regions 78a, 80a, hammer mechanism spring 48a accelerates striker 44a and connecting elements 70a, 72a in impact direction 54a. In the process, connecting elements 70a, 72a move through impact free-running regions 78a, 80a, without experiencing an axial force, until striker 44a meets impact face 42a. Cam guides 62a, 64a are disposed offset by 180 degrees about rotation axis 90a. Cam guides 62a, 64a are disposed one behind the other in the axial direction.

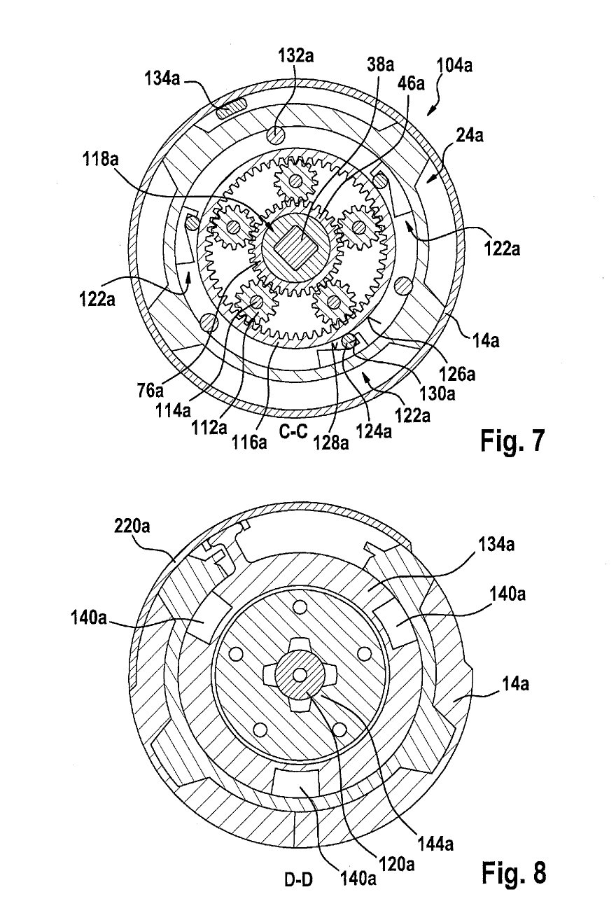

Planetary gear 28a has first planetary gear stage 104a, a second planetary gear stage 106a, a third planetary gear stage 108a and a fourth planetary gear stage 110a. FIG. 7 shows a plane of section C of first planetary gear stage 104a. Planetary gear stages 104a, 106a, 108a, 110a illustrated in FIGS. 7, 12, 13 and 15 have gearwheels with a number of teeth considered suitable by one skilled in the art. The gearwheels of planetary gear stages 104a, 106a, 108a, 110a are in engagement with one another, which in some cases is not shown in that form here. First planetary gear stage 104a increases a first rotational speed of second planetary gear stage 106a to drive hammer mechanism 22a. Second planetary gear stage 106a drives tool spindle 38a at that first rotational speed. Toothing 76a of hammer mechanism spindle 46a forms a sun gear of first planetary gear stage 104a. Toothing 76a meshes with planet gears 112a of first planetary gear stage 104a which are guided by a planet carrier 114a of first planetary gear stage 104a. A ring gear 116a of first planetary gear stage 104a meshes with planet gears 112a of first planetary gear stage 104a.

First impact deactivation device 24a fixes ring gear 116a of first planetary gear stage 104a immovably relative to handheld tool housing 14a in a hammer-drilling mode. First impact deactivation device 24a is intended to switch on striker driving device 50a in a first, clockwise drilling rotational direction and to automatically switch off striker driving device 50a in a second, anticlockwise drilling rotational direction. First impact deactivation device 24a acts on ring gear 116a of first planetary gear stage 104a. First impact deactivation device 24a locks ring gear 116a of first planetary gear stage 104a in the first, clockwise drilling rotational direction. First impact deactivation device 24a releases ring gear 116a of first planetary gear stage 104a in the second, anticlockwise drilling rotational direction, so that it is able to rotate. For that purpose, first impact deactivation device 24a has three clamping mechanisms 122a. Clamping mechanisms 122a each include a blocking element 124a, a first clamping face 126a, a second clamping face 128a, and free-running faces 130a. Blocking element 124a is in the form of a roller. First clamping face 126a forms an external region of a surface of ring gear 116a of first planetary gear stage 104a. Second clamping face 128a is disposed immovably relative to handheld tool housing 14a. Upon operation in the first, clockwise drilling rotational direction, blocking elements 124a become jammed between first clamping faces 126a and second clamping face 128a. Upon operation in the second, anticlockwise drilling rotational direction, free-running faces 130a guide blocking elements 124a and prevent jamming.

In addition, FIG. 7 shows a connecting element 118a which connects tool spindle 38a and a planet carrier 120a of second planetary gear stage 106a in a rotationally rigid manner. Connecting element 118a connects tool spindle 38a and planet carrier 120a of second planetary gear stage 106a in an axially displaceable manner in this case.

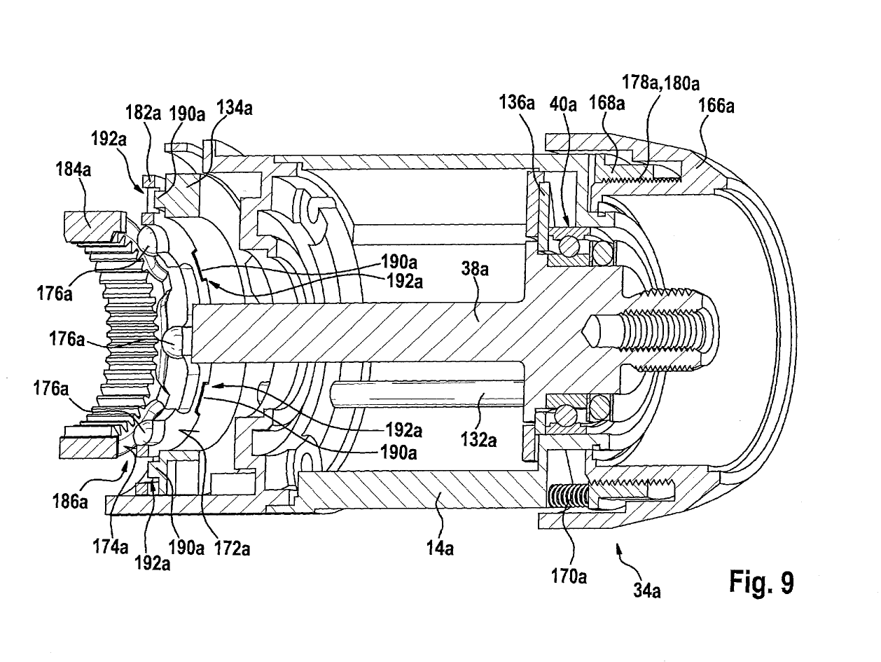

FIGS. 3, 4 and 7 further show three first transmission elements 132a of second impact deactivation device 26a. Transmission elements 132a are in the form of rods. FIG. 8 shows a plane of section D through a control element 134a of handheld tool device 12a. FIG. 9 shows second impact deactivation device 26a in a perspective view in section. Control element 134a supports tool guiding unit 20a in a screwing mode, illustrated in FIGS. 1, 8 and 9, and in a drilling mode in a direction counter to impact direction 54a. A force exerted on tool guiding unit 20a acts, via bearing element 40a, a second transmission element 136a of second impact deactivation device 26a and first transmission elements 132a, on support faces 138a of control element 134a. Control element 134a has three apertures 140a. In a hammer-drilling mode illustrated in FIG. 2, first transmission elements 132a may be pushed into apertures 140a, whereby tool guiding unit 20a is axially movable.

Second impact deactivation device 26a has an impact deactivation coupling 142a. Impact deactivation coupling 142a is formed partially in one piece with planetary gear 28a. Impact deactivation coupling 142a is disposed between first planetary gear stage 104a and second planetary gear stage 106a. Impact deactivation coupling 142a has a first coupling element 144a which is connected to a planet carrier 114a of first planetary gear stage 104a in a rotationally rigid manner. Impact deactivation coupling 142a has a second coupling element 146a which is connected to a planet carrier 120a of second planetary gear stage 106a in a rotationally rigid manner. In the screwing mode illustrated and in the drilling mode, impact deactivation coupling 142a is open. In a hammer-drilling operation, tool spindle 38a transmits an axial coupling force to impact deactivation coupling 142a when the operator presses an application tool against a workpiece. The coupling force closes impact deactivation coupling 142a. In FIG. 2, impact deactivation coupling 142a is shown closed. When the operator removes the application tool from the workpiece, an impact switch spring 148a of handheld tool device 12a opens impact deactivation coupling 142a.

Planet carrier 120a of second planetary gear stage 106a is constructed in two parts. A first part 150a of planet carrier 120a of second planetary gear stage 106a is connected to tool spindle 38a in a rotationally rigid manner. First part 150a of planet carrier 120a is connected to tool spindle 38a in an axially displaceable manner, whereby planet carrier 120a remains rotationally coupled to tool spindle 38a also during an impact. Accordingly, first part 150a is permanently connected to tool spindle 38a. First part 150a of planet carrier 120a is supported to be axially displaceable toward impact switch spring 148a. A second part 152a of planet carrier 120a of second planetary gear stage 106a is connected to first part 150a of planet carrier 120a in a rotationally rigid manner. First part 150a and second part 152a of planet carrier 120a are connected in such a manner as to be axially displaceable relative to each other. First part 150a and second part 152a of planet carrier 120a are connected in a permanently rotationally rigid manner.

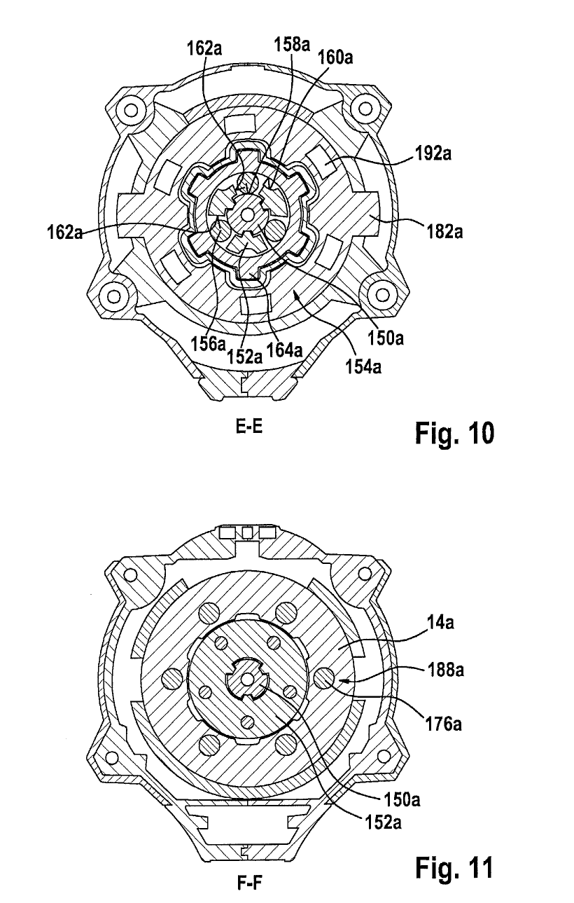

FIG. 10 shows a plane of section of a spindle locking device 154a of handheld tool device 12a. Spindle locking device 154a is intended to connect tool spindle 38a to handheld tool housing 14a in a rotationally rigid manner when a tool torque is applied to tool chuck 36a, for example when an application tool is being clamped into tool chuck 36a. Spindle locking device 154a is constructed partially in one piece with planet carrier 120a of second planetary gear stage 106a. Spindle locking device 154a has blocking elements 156a, first clamping faces 158a, a second clamping face 160a, and free-running faces 162a. Blocking elements 156a are cylindrical. First clamping faces 158a are in the form of regions of a surface of first part 150a of planet carrier 120a of second planetary gear stage 106a. First clamping faces 158a are flat. Second clamping face 160a is in the form of an inner side of a clamping ring 164a of spindle locking device 154a. Clamping ring 164a is connected to handheld tool housing 14a in a rotationally rigid manner. Free-running faces 162a are in the form of regions of a surface of second part 152a of planet carrier 120a of second planetary gear stage 106a. When a tool torque is applied to tool chuck 36a, blocking elements 156a become jammed between first clamping faces 158a and second clamping face 160a. When drive unit 30a drives, free-running faces 162a guide blocking elements 156a over a circular path and prevent jamming. First part 150a and second part 152a of planet carrier 120a are meshed with each other with clearance.

FIGS. 1, 2, 9 and 10 show torque limiting unit 34a. Torque limiting unit 34a is intended to limit a maximum tool torque delivered by tool chuck 36a in a screwing mode. Torque limiting unit 34a includes an operating element 166a, an adjusting element 168a, limiting springs 170a, transmission elements, not shown, first stop faces 172a, a second stop face 174a and limiting elements 176a. Operating element 166a is of an annular configuration. It adjoins tool chuck 36a in the direction of planetary gear 28a. Operating element 166a has a setting thread 178a which is coupled to a setting thread 180a of adjusting element 168a. Adjusting element 168a is supported in a rotationally rigid and axially displaceable manner. Rotation of operating element 166a displaces adjusting element 168a in the axial direction. Limiting springs 170a are supported on one side against adjusting element 168a. Limiting springs 170a are supported on another side on a stop element 182a of torque limiting unit 34a via the transmission elements. A surface of stop element 182a has first stop faces 172a. Stop element 182a is supported to be movable in the axial direction toward limiting springs 170a in the screwing mode. Second stop face 174a is in the form of a region of a surface of a ring gear 184a of second planetary gear stage 106a. Second stop face 174a has trough-shaped depressions 186a. Limiting elements 176a are spherical. Limiting elements 176a are supported to be displaceable in impact direction 54a in tubular apertures 188a. FIG. 11 shows a plane of section F of torque limiting unit 34a. In a screwing operation, limiting elements 176a are disposed in trough-shaped depressions 186a. In that case, limiting elements 176a fasten ring gear 184a of second planetary gear stage 106a in a rotationally rigid manner. When the set maximum tool torque is reached, limiting elements 176a press stop element 182a away toward limiting springs 170a. Then limiting elements 176a each jump into the next one of trough-shaped depressions 186a. In that operation, ring gear 184a of second planetary gear stage 106a rotates, as a result of which the screwing operation is interrupted.

Control element 134a of handheld tool device 12a has support elements 190a which prevent axial movement of stop element 182a at least in a drilling mode. For that purpose, support elements 190a support stop element 182a in the axial direction. Stop element 182a has screw apertures 192a which stop elements 182a enter when the maximum tool torque is reached in a screwing mode illustrated especially in FIG. 9. Support elements 190a are disposed accordingly in a screw position of control element 134a. In a hammer-drilling mode, support elements 190a also prevent axial movement of stop element 182a and hence a response of torque limiting unit 34a.

Alternatively, stop elements could also be so disposed in a hammer-drilling mode that they are able to enter screw apertures. In that manner, a torque limiting unit would be active in the hammer-drilling mode.

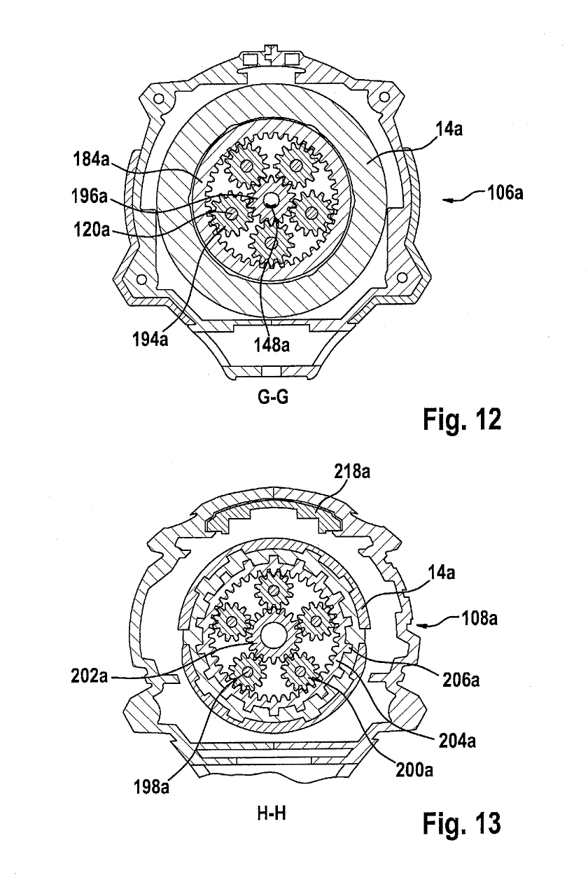

FIG. 12 shows a plane of section G of second planetary gear stage 106a. Ring gear 184a of second planetary gear stage 106a is secured against complete rotation in handheld tool housing 14a at least in a drilling mode. Planet gears 194a of second planetary gear stage 106a mesh with ring gear 184a and a sun gear 196a of second planetary gear stage 106a.

FIG. 13 shows a plane of section H of third planetary gear stage 108a. Sun gear 196a of second planetary gear stage 106a is connected to a planet carrier 198a of third planetary gear stage 108a in a rotationally rigid manner. Planet gears 200a of third planetary gear stage 108a mesh with a sun gear 202a and a ring gear 204a of third planetary gear stage 108a. Ring gear 204a of third planetary gear stage 108a has toothing 206a which connects ring gear 204a of third planetary gear stage 108a to handheld tool housing 14a in a rotationally rigid manner in a first gear ratio.

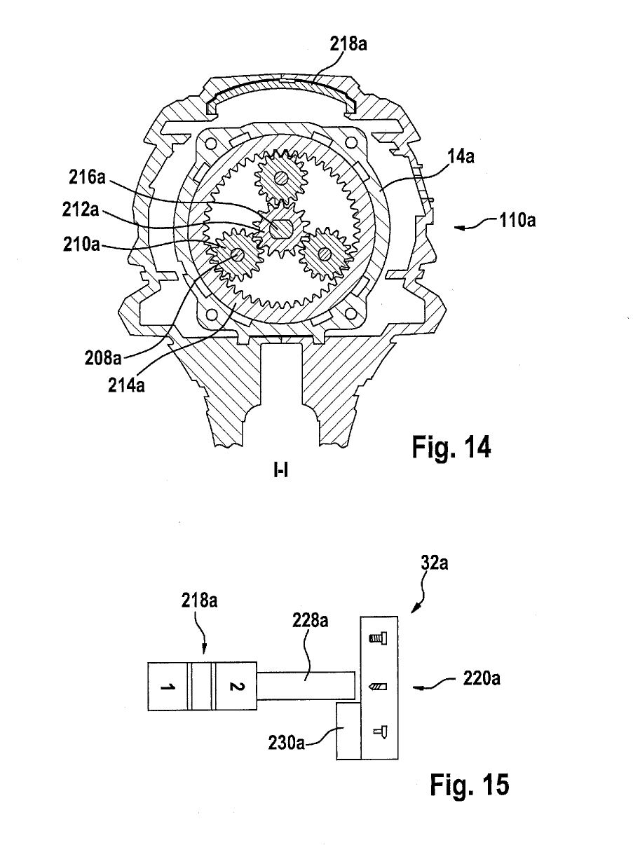

FIG. 14 shows a plane of section I of third planetary gear stage 108a. Sun gear 202a of third planetary gear stage 108a is connected to a planet carrier 208a of fourth planetary gear stage 110a in a rotationally rigid manner. Planet gears 210a of fourth planetary gear stage 110a mesh with a sun gear 212a and a ring gear 214a of fourth planetary gear stage 110a. Ring gear 214a is connected to handheld tool housing 14a in a rotationally rigid manner. Sun gear 212a of fourth planetary gear stage 110a is connected in a rotationally rigid manner to a rotor 216a of drive unit 30a.

Ring gear 204a of third planetary gear stage 108a is supported to be displaceable in the axial direction, as shown in FIG. 2. In the first gear ratio, ring gear 204a of third planetary gear stage 108a is connected to handheld tool housing 14a in a rotationally rigid manner. In the second gear ratio, ring gear 204a of third planetary gear stage 108a is connected to planet carrier 208a of fourth planetary gear stage 110a in a rotationally rigid manner and is supported to be rotatable relative to handheld tool housing 14a. This produces a reduction ratio of the first gear ratio between rotor 216a of drive unit 30a and planet carrier 198a of third planetary gear stage 108a, which reduction ratio is greater than a reduction ratio of the second gear ratio.

Operating device 32a has a first operating element 218a and a second operating element 220a. First operating element 218a is disposed on a side of handheld tool housing 14a remote from hand grip 18a. It is supported to be movable parallel to the axial direction of planetary gear 28a. First operating element 218a is connected to ring gear 204a of third planetary gear stage 108a in the axial direction via an adjusting element 222a of operating device 32a. Ring gear 204a of third planetary gear stage 108a has a keyway 224a with which adjusting element 222a engages. Accordingly, ring gear 204a of third planetary gear stage 108a is connected to adjusting element 222a in the axial direction in such a manner as to be axially rotatable relative to adjusting element 222a. Adjusting element 222a is constructed to be resilient, whereby the gear ratio may be adjusted independently of a rotational position of ring gear 204 of third planetary gear stage 108a. When first operating element 218a is pushed in the direction of tool chuck 36a, the first gear ratio is set. When second operating element 220a is pushed away from tool chuck 36a, the second gear ratio is set.

Second operating element 220a is disposed on a side of handheld tool housing 14a remote from hand grip 18a. Second operating element 220a is disposed so as to be displaceable about an axis oriented parallel to the axial direction of planetary gear 28a. Second operating element 220a is connected to control element 134a of handheld tool device 12a in a rotationally rigid manner. With second operating element 220a, the screwing mode, the drilling mode and the hammer-drilling mode may be set. When second operating element 220a is pushed to the left as viewed in impact direction 54a, the hammer-drilling mode is set. When second operating element 220a is pushed to the right as viewed in impact direction 54a, the screwing mode is set. When second operating element 220a is situated centrally as viewed in impact direction 54a, the drilling mode is set.

FIG. 15 shows schematically a safety device 226a of handheld tool device 12a, which, in the hammer-drilling mode, prevents operation in the first gear ratio. In FIG. 15, first gear ratio and drilling mode have been set. Safety device 226a is constructed partially in one piece with operating device 32a. A first inhibiting element 228a of safety device 226a is integrally formed on first operating element 218a. A second inhibiting element 230a of safety device 226a is integrally formed on second operating element 220a. Inhibiting elements 228a are each of a tongue-shaped configuration. First inhibiting element 228a extends in the direction of second operating element 220a. Second inhibiting element 230a extends in the direction of first operating element 218a. Safety device 226a prevents switching over into the hammer-drilling mode when the first gear ratio is set. Safety device 226a prevents switching over into the first gear ratio when the hammer-drilling mode is set.

Drive unit 30a is in the form of an electric motor. Drive unit 30a has a maximum torque which causes a maximum tool torque of more than 15 Nm in the first gear ratio and of less than 15 Nm in the second gear ratio. The maximum tool torque in the first gear ratio is 30 Nm. The maximum tool torque in the second gear ratio is 10 Nm. The tool torque is to be specified in this case in accordance with the DIN EN 60745 standard.

In a hammer-drilling mode, impact switch spring 148a of handheld tool device 12a opens impact deactivation coupling 142a when the operator removes the application tool from the workpiece. Impact switch spring 148a is disposed coaxially with planetary gear stages 104a, 106a, 108a, 110a of planetary gear 28a. Second planetary gear stage 106a and third planetary gear stage 108a each surround impact switch spring 148a on at least one plane that is oriented perpendicularly to the axial direction of planetary gear 28a. Second planetary gear stage 106a and third planetary gear stage 108a are each operatively disposed between at least two further planetary gear stages 104a, 106a, 108a, 110a of planetary gear 28a. Planet carrier 120a of second planetary gear stage 106a supports impact switch spring 148a on a side remote from tool chuck 36a.

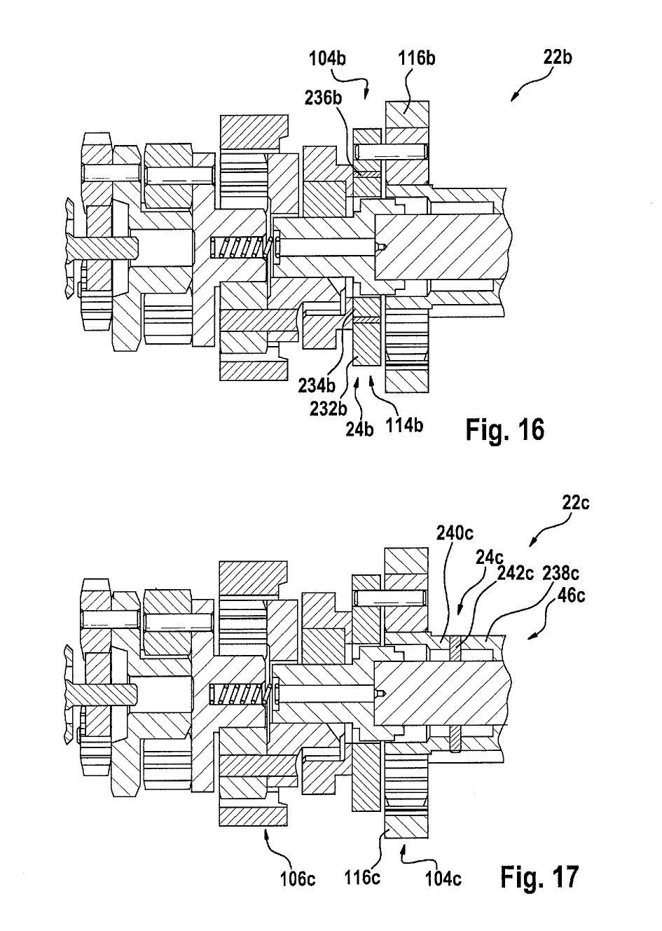

In FIGS. 16 through 19, further exemplary embodiments of the present invention are shown. The following descriptions and the drawings are substantially restricted to the differences between the exemplary embodiments; with regard to components having identical names, especially with regard to components having identical reference characters, reference may also be made in principle to the drawings and/or the description of the other exemplary embodiments, especially FIGS. 1 through 15. To distinguish between the exemplary embodiments, the letter “a” is placed after the reference numerals of the exemplary embodiment in FIGS. 1 through 15. In the exemplary embodiments of FIGS. 16 through 19, the letter “a” is replaced by the letters “b” through “e”.

In FIG. 16, a further, alternative exemplary embodiment of first impact deactivation device 24a is shown schematically. A planet carrier 114b of a first planetary gear stage 104b is constructed in two parts. A first part 232b of planet carrier 114b guides planet gears 112b of first planetary gear stage 104b. A second part 234b of planet carrier 114b is rotationally coupled to a second planetary gear stage 106b. A first impact deactivation device 24b of a hammer mechanism 22b has a freewheel 236b considered suitable by one skilled in the art, which freewheel 236b connects first part 232b and second part 234b of planet carrier 114b in a rotationally rigid manner in the case of a clockwise drilling rotational direction and separates them in the case of an anticlockwise drilling rotational direction. A ring gear 116b of first planetary gear stage 104b is connected to a handheld tool housing in a permanently rotationally rigid manner.

In FIG. 17, a next exemplary embodiment of a first impact deactivation device 24c is shown schematically. A hammer mechanism spindle 46c of a hammer mechanism 22c is constructed in two parts. A first part 238c of hammer mechanism spindle 46c is connected to a striker driving device. A second part 240c of hammer mechanism spindle 46c is connected to a second planetary gear stage 106c. First impact deactivation device 24c has a freewheel 242c considered suitable by one skilled in the art, which freewheel 242c connects first part 238b and second part 240c of hammer mechanism spindle 46c in a rotationally rigid manner in the case of a clockwise drilling rotational direction and separates them in the case of an anticlockwise drilling rotational direction. A ring gear 116a of first planetary gear stage 104c is connected to a handheld tool housing in a permanently rotationally rigid manner.

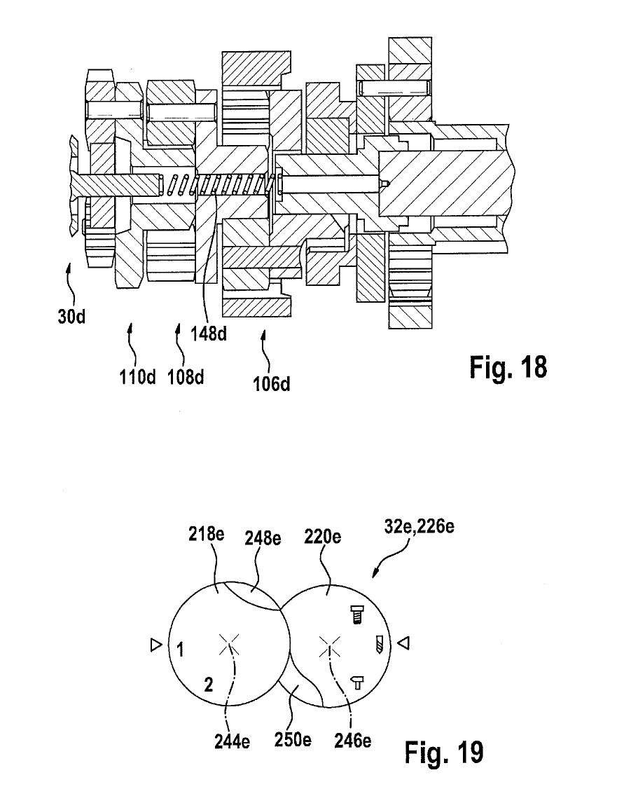

In FIG. 18, a further exemplary embodiment of an impact switch spring 148d is illustrated. A second planetary gear stage 106d supports impact switch spring 148d on a side toward a tool chuck. A drive unit 30d supports impact switch spring 148d on a side remote from a tool chuck. Second planetary gear stage 106d, a third planetary gear stage 108d and a fourth planetary gear stage 110d each surround impact switch spring 148d on at least one plane oriented perpendicularly to an axial direction of planetary gear stages 106d, 108d, 110d. Drive unit 30d is connected to a portion of planetary gear stage 110d in a rotationally rigid manner.

FIG. 19 shows an alternative exemplary embodiment of operating device 32e and of a safety device 226e. Operating device 32e has a first operating element 218e and a second operating element 220e. Operating elements 218e, 220e are supported so as to be pivotable about rotation axes 244e, 246e. Operating elements 218e, 220e have a disc-shaped basic shape. First operating element 218e is connected, in a manner not shown in detail, to a planetary gear by way of a mechanism considered suitable by one skilled in the art. With first operating element 218e, a first gear ratio and a second gear ratio may be set. Second operating element 220e is connected, in a manner not shown in detail, to a control element by way of a mechanism considered suitable by one skilled in the art. With second operating element 220e, a screwing mode, a drilling mode and a hammer-drilling mode may be set. Furthermore, a chisel mode could be set.

Safety device 226e has a free-running region 248e delimited by first operating element 218e. Safety device 226e has a free-running region 250e delimited by second operating element 220e. Free-running region 248e of first operating element 218e makes it possible to set the screwing mode, the drilling mode and the hammer-drilling mode when a second gear ratio is set. Free-running region 250e of second operating element 220e makes it possible to set the screwing mode and the drilling mode when a first gear ratio is set. In the hammer-drilling mode, safety device 226e prevents setting of the first gear ratio. When first gear ratio is set, safety device 226e prevents setting of the hammer-drilling mode.

1-14. (canceled)

15. A handheld tool device, comprising:
a hammer mechanism which includes a striker and at least one cam guide which drives the striker at least in a hammer-drilling mode, wherein the striker has at least a portion of the cam guide.

16. The handheld tool device as recited in claim 15, wherein the cam guide has an impact free-running region.

17. The handheld tool device as recited in claim 16, wherein the cam guide has an impact pull-up region.

18. The handheld tool device as recited in claim 17, wherein the cam guide has a mounting aperture.

19. The handheld tool device as recited in claim 15, wherein the hammer mechanism includes a hammer mechanism spindle which has at least a portion of the cam guide.

20. The handheld tool device as recited in claim 19, wherein the hammer mechanism spindle has a guide cam of the cam guide.

21. The handheld tool device at least as recited in claim 19, wherein the striker at least substantially surrounds the hammer mechanism spindle on at least one plane.

22. The handheld tool device as recited in claim 19, wherein the hammer mechanism has a connecting element which in at least one operating state transmits a motion to the striker.

23. The handheld tool device as recited in claim 19, further comprising:
a tool spindle, wherein the striker at least substantially surrounds the tool spindle on at least one plane.

24. The handheld tool device at least as recited in claim 23, wherein the tool spindle is disposed at least substantially coaxially with the hammer mechanism spindle.

25. The handheld tool device as recited in claim 15, wherein the hammer mechanism has a striker guide which supports the striker in a rotationally rigid manner.

26. The handheld tool device as recited in claim 15, further comprising:
a handheld tool housing, wherein the hammer mechanism has a hammer mechanism spring which is supported on the striker and on the handheld tool housing.

27. The handheld tool device as recited in claim 19, wherein the hammer mechanism includes a first cam guide and a second cam guide.
